(19) United States
(12) Patent Application Publication
(10) Pub. No.: US 2019/0278450 A1
(43) Pub. Date: Sep. 12, 2019

(54) ELECTRONIC DEVICE AND METHOD FOR CONTROLLING DISPLAY THEREOF

(71) Applicant: SHENZHEN ROYOLE TECHNOLOGIES CO. LTD., Shenzhen (CN)

(72) Inventor: Jinxin LI, Shenzhen (CN)

(73) Assignee: SHENZHEN ROYOLE TECHNOLOGIES CO., LTD., Shenzhen (CN)

(21) Appl. No.: 16/461,214

(22) PCT Filed: Nov. 21, 2016
(86) PCT No.: PCT/CN2016/106601

§ 371 Date: May 15, 2019

(51) Int. Cl. G06F 3/0485; G06F 3/03; G06F 1/16; G06F 3/041

(52) U.S. Cl. CPC G06F 3/0485; G06F 3/0312; G06F 3/0416; G06F 1/1643; G06F 1/1694

(57) ABSTRACT

An electronic device and a method for controlling display of the electronic device are provided. The electronic device includes a display screen, a processor, and a motion sensor. The motion sensor is operable to sense a motion of the electronic device. The display screen defines a sub-display area thereon. The processor determines a first display content corresponding to the sub-display area and correspondingly controls the first display content portion when the motion sensor senses a first motion of the electronic device.

### RELATED APPLICATION

The present application is a National Phase of International Application Number PCT/CN2016/106601, filed Nov. 21, 2016.

### TECHNICAL FIELD

The present disclosure relates to an electronic device, and more particularly relates to an electronic device with a display function and a method for controlling display of the electronic device.

### BACKGROUND

At present, portable electronic devices, such as mobile phones and tablet computers, have been widely used and have greatly facilitated lives of the people. With the pursuit of large screens, the size of the mobile phones and the like become larger and larger. For example, the mobile phones with 5.5-inch screen are now popular. As the size of the mobile phones increases, it is not easy to be operable with one hand any more. It usually requires one hand to hold the mobile phone and the other to operate the mobile phone, which increases the inconvenience of the operation.

### SUMMARY

Embodiments of the present disclosure provide an electronic device and a method for controlling display of the electronic device which may conveniently control a display content of the electronic device by one hand.

An embodiment of the present disclosure provides an electronic device. The electronic device includes a display screen and a processor. The electronic device further includes a motion sensor. The motion sensor is operable to sense a motion of the electronic device. The display screen defines a sub-display area thereon. The processor is operable to determine a first display content corresponding to the sub-display area and correspondingly control the first display content when the motion sensor senses a first motion of the electronic device.

An embodiment of the present disclosure provides a method for controlling a content displayed on a display screen of an electronic device. The method includes: sensing a motion of the electronic device; determining a first display content corresponding to a sub-display area of the display screen and correspondingly controlling the first display content when the motion sensor senses a first motion of the electronic device.

The electronic device and the method for controlling display in the present disclosure may control the electronic device by shaking or rotating the electronic device with one hand.

### BRIEF DESCRIPTION OF THE DRAWINGS

To better illustrate the technical solutions of embodiments of the present disclosure, the following descriptions will briefly illustrate the accompanying drawings described in the embodiments. Obviously, the following described accompanying drawings are merely some embodiments of the present disclosure. Those skilled in the art may obtain other accompanying drawings according to the described accompanying drawings without creative efforts.

FIG. 1 is a block diagram of an electronic device according to an embodiment of the present disclosure.

FIG. 2 is a schematic view of a display screen of an electronic device according to an embodiment of the present disclosure.

FIG. 3 is a schematic view of a display screen of an electronic device according to an embodiment of the present disclosure, with the display screen displaying an opening progress bar of a link.

FIG. 4 is a schematic view of an electronic device according to an embodiment of the present disclosure, with the electronic device being in a preset position.

FIG. 5 is a flow chart of a method for controlling display of an electronic device according to an embodiment of the present disclosure.

FIG. 6 is a sub-flow chart of operations at block S502 in FIG. 5.

FIG. 7 is another sub-flow chart of operations at block S502 in FIG. 5.

FIG. 8 is an additional sub-flow chart of operations at block S502 in FIG. 5.

### DETAILED DESCRIPTION OF ILLUSTRATED EMBODIMENTS

The technical solutions of embodiments of the present disclosure will be described clearly and completely in combination with the accompanying drawings of the embodiments of the present disclosure. Obviously, the described embodiments are merely a part of embodiments of the present disclosure, but not all of the embodiments. All other embodiments obtained by those skilled in the art without creative efforts based on the embodiments of the present disclosure shall fall within the protection scope of the present disclosure.

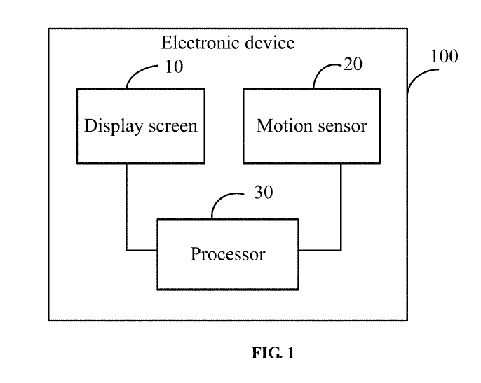

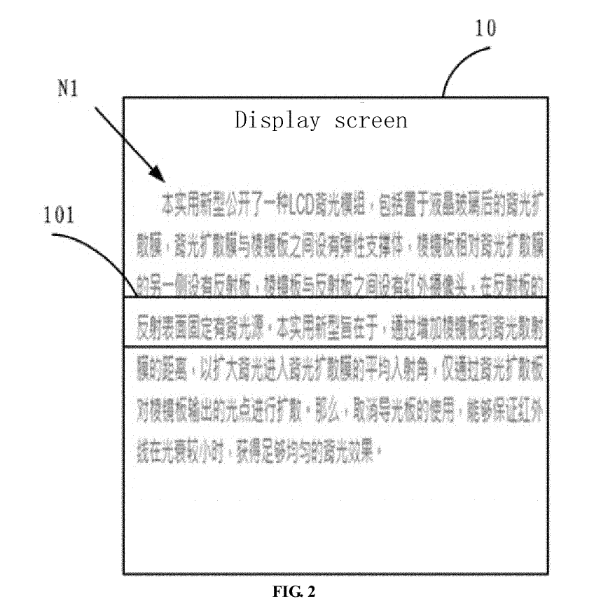

FIG. 1 illustrates a block diagram of an electronic device according to an embodiment of the present disclosure. The electronic device 100 includes a display screen 10, a motion sensor 20, and a processor 30. As illustrated in FIG. 2, the display screen 10 defines a sub-display area 101 thereon in advance. The sub-display area 101 is operable to display first display content. The display screen 10 is operable to display a second display content N1. The second display content N1 displayed on the display screen 10 is a content displayed on the entire display area of the display screen 10, the first display content displayed on the sub-display area 101 is a part of the second display content N1 corresponding to the sub-display area 101. The motion sensor 20 is operable to sense a motion of the electronic device 100. The processor 30 is connected to the display screen 10 and the motion sensor 20. The processor 30 is operable to control the content currently displayed on the display screen 10 based on the motion of the electronic device 100 sensed by the motion sensor 20.

The processor 30 determines first display content corresponding to the sub-display area 101 and correspondingly control the first display content when the motion sensor 20 senses a first motion of the electronic device 100.

In one embodiment, when the first display content corresponding to the sub-display area 101 is a text, the first display content corresponding to the sub-display area 101 is the text in the sub-display area 101 or the entire paragraph where the text in the sub-display area 101 is located. The corresponding operation performed on the first display content is an operation selected from a group consisting of a copy operation, a marking operation, a cutting operation, and the like.

In one embodiment, when the first display content corresponding to the sub-display area 101 is a link, the first display content corresponding to the sub-display area 101 is the link in the sub-display area 101 or the entire link to which the link in the sub-display area 101 belongs. The corresponding operation performed on the first display content is an operation selected from a group consisting of an opening operation, a copy operation, a collecting operation, and the like. When the entire link is in the sub-display area 101, the first display content corresponding to the sub-display area 101 is the entire link. When the link in the sub-display area 101 is only a part of a long link, the first display content corresponding to the sub-display area 101 is the entire long link to which the part of link in the sub-display area 101 belongs.

In one embodiment, when the first display content corresponding to the sub-display area 101 is a picture, the first display content corresponding to the sub-display area 101 is the picture in the sub-display area 101 or the entire picture to which the picture in the sub-display area 101 belongs. The corresponding operation performed on the first display content is an operation selected from a group consisting of a copy operation, a marking operation, a storing operation, and the like.

Obviously, the specific control to or operation on different first display content may be preset by the user through the electronic device in advance. For example, the particular operation performed on the first display content may be preset as the copy operation and the like when the display content is the text. The types of the operations, such as copy operation, marking operation and the like are only illustrated implementations, and are not limited to the types of operations described above.

Therein, in one embodiment, the first motion may be that the electronic device 100 moves a preset number of times in a direction substantially perpendicular to the display screen 10. The preset number of times may be any number greater than or equal to 1, such as once, twice, and the like. In other embodiments, the first motion may be that the electronic device 100 moves a preset number of times in a direction substantially parallel to the display screen 10. For example, the electronic device 100 may move up, down, leftward, or rightward in the direction parallel to the display screen 10 once, twice and other preset number of times.

Therefore, the user may control the first display content corresponding to the sub-display area 101 by holding the electronic device 100 with one hand and operating the electronic device 100 a preset number of times, thereby facilitating the operation of the user.

The sub-display area 101 is a part of the entire display area of the display screen 10. As illustrated in FIG. 2, in one embodiment, the sub-display area 101 is a rectangular area having a certain width located in the middle position of the display screen 10. Obviously, the sub-display area 101 may also be located at the top or the bottom of the display screen 10. In other embodiments, the sub-display area 101 may also be a linear area or a circular area or the like.

In some embodiments, the processor 30 controls the scrolling operation of the second display content N1 displayed on the display screen 10 when the motion sensor 20 senses a second motion of the electronic device 100. In the embodiment, the second motion includes a forward tilting motion or a backward tilting motion. Therein, the forward tilting motion of the electronic device 100 is a motion of the top of the electronic device 100 rotating toward the user; and the backward tilting motion of the electronic device 100 is a motion of the top of the electronic device 100 rotating away from the user. Specifically, the processor 30 controls the second display content N1 to scroll up when the forward tilting motion of the electronic device 100 is sensed and controls the second display content N1 to scroll down when the backward tilting motion of the electronic device 100 is sensed. Obviously, in other embodiments, the processor 30 may control the second display content N1 to scroll down when the forward tilting motion of the electronic device 100 is sensed and control the second display content N1 to scroll up when the backward tilting motion of the electronic device 100 is sensed.

In some embodiments, the motion sensor 20 may further sense a motion angle of the electronic device 100 when sensing the forward tilting motion or the backward tilting motion of the electronic device 100, that is, a deviation angle of the electronic device 100 from the beginning of the motion to the end of the motion. The processor 30 further determines a scrolling speed of the second display content N1 according to the motion angle and controls the second display content N1 to scroll in a corresponding direction at the scrolling speed.

In the embodiment, the second motion further includes a leftward tilting motion or a rightward tilting motion. The processor 30 performs a page turning operation, a forward operation, or a backward operation on the second display content N1 displayed on the display screen 10 when the motion sensor 20 senses the leftward tilting motion or the rightward tilting motion of the electronic device 100.

For example, when the electronic device is an e-book, the second display content N1 is a content of an e-book. The processor 30 may control the current second display content N1 displayed on the display screen 10 to be turned to the previous page or to the next page when the motion sensor 20 senses the leftward tilting motion or the rightward tilting motion of the electronic device 100. When the second display content N1 is a browser or a folder, the processor 30 displays the previous browsing interface or enters the next browsing interface, or displays the previous level folder or enters the next level folder when the motion sensor 20 senses the leftward tilting motion or the right tilting motion of the electronic device 100.

Therein, the second display content N1 displayed on the display screen 10 is a content displayed on the entire display area of the display screen 10, the first display content in the sub-display area 101 is a part of the second display content N1 displayed corresponding to the sub-display area 101.

Therein, the display screen 10 is a touch display screen. The processor 30 may be a central processing unit (CPU), a microcontroller, a microprocessor, a digital signal processor, a single chip and so on.

The processor 30 is further operated to receive a touch signal generated by the display screen 10 in response to a touch operated by the user. The processor 30 is further operable to control the second display content N1 to stop scrolling when the touch signal is received and the second display content N1 displayed on the display screen 10 is scrolling.

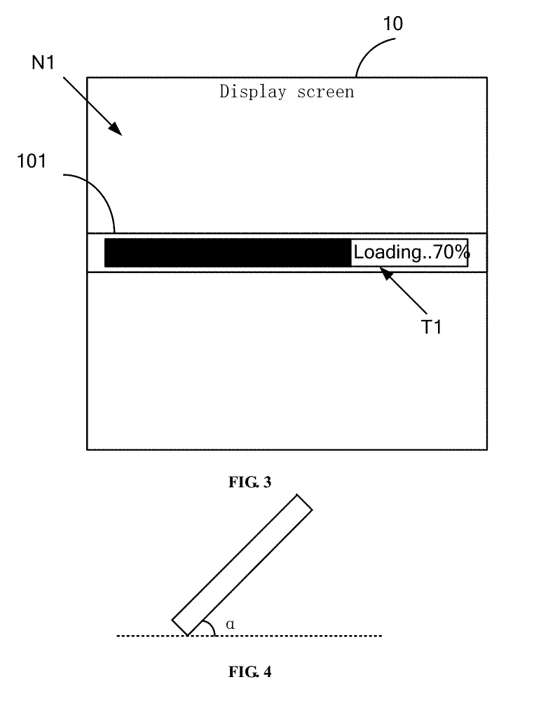

As illustrated in FIG. 3, in some embodiments, when controlling the second display content N1 to scroll up or down in response to the forward tilting motion or the backward tilting motion of the electronic device 100, the processor 30 changes the color of a link to remind the user when the link moves to the sub-display area 101. The processor 30 opens the link and displays an opening progress bar T1 (as illustrated in FIG. 3) of the link when the motion sensor 20 senses the electronic device 100 returns to a preset position. The processor 30 controls the second display content N1 to jump to the link interface when the opening progress bar T1 is completed. Before the opening progress bar T1 is completed, the processor 30 continues to control the second display content N1 to scroll up or down and stop opening the link when the motion sensor 20 senses the forward tilting motion or the backward tilting motion again.

As illustrated in FIG. 4, the preset position is a position where the electronic device 100 is located at a preset angle α. The preset angle α is an angle between a horizontal surface or a support surface and the electronic device 100 when the electronic device 100 is held by the user or the electronic device 100 is tilted on a support surface such as a table. In one embodiment, the preset angle α ranges from 38 to 45 degrees.

Therein, the motion sensor 20 may be a gyroscope, a gravity sensor and the like.

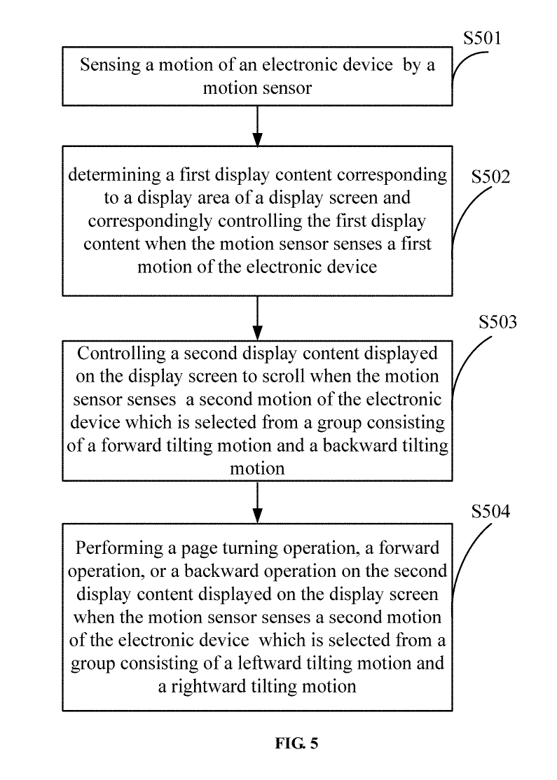

FIG. 5 illustrates a flow chart of a method for controlling display of an electronic device. The method is operable to control the content displayed on the display screen 10 of the aforementioned electronic device 100. The method includes the operations at the following blocks.

At block S501, the motion of the electronic device 100 is sensed by a motion sensor 20.

At block S502, when the motion sensor 20 senses a first motion of the electronic device 100, the electronic device 100 determines the first display content corresponding to the sub-display area 101 and correspondingly controls the first display content.

Therein, in some embodiments, the method further includes operations at the following blocks.

At block S503, when the motion sensor 20 senses a second motion of the electronic device 100, the processor 30 controls the scrolling operation of the second display content N1 displayed on the display screen 10. In the embodiment, the second motion is selected from a group consisting of a forward tilting motion and a backward tilting motion. Specifically, the processor 30 controls the second display content N1 to scroll up when the forward tilting motion of the electronic device 100 is sensed, and controls the second display content N1 to scroll down when the backward tilting motion of the electronic device 100 is sensed. In addition, the motion sensor 20 further senses a motion angle of the electronic device 100 when sensing the forward tilting motion or the backward tilting motion of the electronic device 100. The operations at block S503 specifically include the following detailed operations. The processor 30 further determines a scrolling speed of the second display content N1 according to the motion angle and controls the second display content N1 to scroll in the corresponding direction at the scrolling speed when the motion sensor 20 senses the forward tilting motion or the backward tilting motion of the electronic device 100.

Therein, in some embodiments, the second motion is selected from a group consisting of a leftward tilting motion and a rightward tilting motion, the method further includes operations at the following blocks.

At block S504, the processor 30 performs a page turning operation, a forward operation, or a backward operation on the second display content N1 displayed on the display screen 10 when the motion sensor 20 senses the leftward tilting motion or the rightward tilting motion of the electronic device 100.

In some embodiments, when controlling the second display content N1 to scroll up or down in response to the forward tilting motion or the backward tilting motion of the electronic device 100, the processor 30 changes the color of the link to remind the user when a link moves to the sub-display area 101. The processor 30 further opens the link and displays an opening progress bar T1 of the link when the motion sensor 20 senses the electronic device 100 returns to a preset position. The processor 30 further controls the second display content N1 jump to the link interface when the opening progress bar T1 is completed.

Therein, before the opening progress bar T1 is completed, when the motion sensor 20 senses the forward tilting motion or the backward tilting motion again, the processor 30 continues to control the second display content N1 to scroll up or down and stops opening the link.

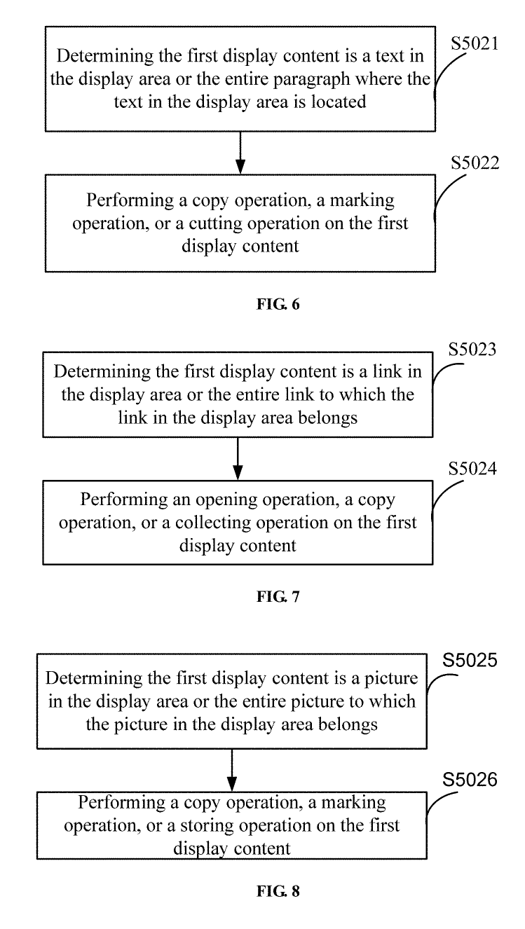

FIG. 6 illustrates a sub-flowchart of operations at block S502. When the first display content is a text, the operations at block S502 include operations at the following blocks.

At block S5021, it is determined that the first display content is the text located in the sub-display area 101 or the entire paragraph where the text in the sub-display area 101 is located.

At block S5022, one operation selected from a group consisting of a copy operation, a marking operation, a cutting operation, and the like, is performed on the corresponding first display content.

FIG. 7 illustrates another sub-flowchart of operations at S502. When the second display content N1 is a link, the operations at block S502 include operations at the following blocks.

At block S5023, it is determined that the corresponding first display content displayed is the link located in the sub-display area 101 or the entire link to which the link in the sub-display area 101 belongs.

At block S5024, one operation selected from a group consisting of an opening operation, a copy operation, or a collecting operation, and the like, is performed on the corresponding first display content.

FIG. 8 illustrates an additional sub-flowchart of operations at block S502. When the second display content N1 is a picture, the operations at block S502 include operations at the following blocks.

At block S5025, it is determined that the corresponding first display content is the picture located in the sub-display area 101 or the entire picture to which the picture in the sub-display area 101 belongs.

At block S5026, one operation selected from a group consisting of a copy operation, a marking operation, or a storing operation, and the like, is performed on the corresponding first display content.

Therefore, the second display content N1 displayed is controlled by the user through holding the electronic device 100 with one hand to perform the rotating or the shaking operation, which greatly facilitates the operation of the user.

The embodiments of the present disclosure are described in detail above. It should be noted that those skilled in the art may make some modifications and improvements without departing from the principle of the present disclosure. Those modifications and improvements are also considered to be within the scope of the present disclosure.

What is claimed is:

1. An electronic device, comprising:
a display screen defining a sub-display area thereon;
a motion sensor being operable to sense a motion of the electronic device; and
a processor being operable to determine a first display content corresponding to the sub-display area and correspondingly control the first display content when the motion sensor senses a first motion of the electronic device.

2. The electronic device according to claim 1, wherein the first motion is that the electronic device moves a preset number of times in a direction perpendicular to the display screen or in a direction parallel to the display screen.

3. The electronic device according to claim 1, wherein the processor controls a second display content corresponding to the entire display area of the display screen to scroll when the motion sensor senses a second motion of the electronic device, and the second motion comprises a forward tilting motion and a backward tilting motion.

4. The electronic device according to claim 3, wherein the processor controls the second display content displayed on the display screen to scroll up when the forward tilting motion of the electronic device is sensed, and the processor controls the second display content displayed on the display screen to scroll down when the backward tilting motion of the electronic device is sensed.

5. The electronic device according to claim 3, wherein the motion sensor further senses a motion angle of the electronic device when the forward tilting motion or the backward tilting motion of the electronic device is sensed, and the processor determines a scrolling speed of the second display content according to the motion angle and controls the second display content to scroll in the corresponding direction at the scrolling speed.

6. The electronic device according to claim 3, wherein the processor is further operated to receive a touch signal generated by the display screen in response to a touch operated by the user, and the processor controls the second display content displayed on the display screen to stop scrolling when receiving the touch signal during the scrolling of the second display content.

7. The electronic device according to claim 1, wherein the processor performs a page turning operation, a forward operation, or a backward operation on the second display content displayed on the display screen when the motion sensor senses a second motion of the electronic device, and wherein the second motion comprises a leftward tilting motion and a rightward tilting motion.

8. The electronic device according to claim 1, wherein when the first display content is a text, the first display content corresponding to the sub-display area is the text in the sub-display area or the entire paragraph where the text in the sub-display area is located, and the corresponding operation performed on the first display content is an operation selected from a group consisting of a copy operation, a marking operation, and a cutting operation.

9. The electronic device according to claim 1, wherein when the first display content is a link, the first display content corresponding to the sub-display area is the link in the sub-display area or the entire link to which the link in the sub-display area belongs, and the corresponding operation performed on the first display content is an operation selected from a group consisting of an opening operation, a copy operation, and a collecting operation.

10. The electronic device according to claim 1, wherein when the first display content is a picture, the first display content corresponding to the sub-display area is the picture in the sub-display area, or the entire picture to which the picture in the sub-display area belongs, and the corresponding operation performed on the first display content is an operation selected from a group consisting of a copy operation, a marking operation, and a storing operation.

11. The electronic device according to claim 4, wherein when controlling the second display content to scroll up or down in response to the forward tilting motion or backward tilting motion of the electronic device, the processor further changes the color of a link when the link moves to the sub-display area, the processor opens the link and displays an opening progress of the link when the motion sensor senses that the electronic device returns to a preset position, and the processor controls the second display content to jump to a link interface when the opening progress bar is completed.

12. A method for controlling a content displayed on a display screen of an electronic device, comprising:
sensing a motion of the electronic device by a motion sensor; and
determining a first display content corresponding to a sub-display area of the display screen and correspondingly controlling the first display content when the motion sensor senses a first motion of the electronic device.

13. The method according to claim 12, further comprises:
controlling a second display content displayed on the display screen to scroll when the sensor senses that a second motion of the electronic device, and wherein the second motion comprises a forward tilting motion and a backward tilting motion.

14. The method according to claim 13,
wherein the controlling a second display content displayed on the display screen to scroll when the sensor senses that a second motion of the electronic device, wherein the second motion comprises a forward tilting motion and a backward tilting motion, comprises:
sensing a motion angle of the electronic device when the motion sensor senses the forward tilting motion or the backward tilting motion of the electronic device; and
determining a scrolling speed of the second display content according to the motion angle and controlling the second display content to scroll in a corresponding direction at the scrolling speed.

15. The method according to claim 13, further comprises:
performing a page turning operation, a forward operation, or a backward operation on the second display content displayed on the display screen when the motion sensor senses the leftward tilting motion, or the rightward tilting motion of the electronic device.

16. The method according to claim 13, wherein when the first display content is a text, the determining a first display content corresponding to a sub-display area of the display screen and correspondingly controlling the first display content when the motion sensor senses a first motion of the electronic device, comprises:
determining the corresponding first display content is the text in the sub-display area or the entire paragraph where the text in the sub-display area is located, and
performing a copy operation, a marking operation, or a cutting operation on the corresponding first display content.

17. The method according to claim 13, wherein when the display content is a link, the determining a first display content corresponding to a sub-display area of the display screen and correspondingly controlling the first display content when the motion sensor senses a first motion of the electronic device, comprises:
determining the corresponding first display content is the link in the sub-display area or the entire link to which the link in the sub-display area belongs; and
performing an opening operation, a copy operation, or a collecting operation on the corresponding first display content.

18. The method according to claim 13, wherein when the first display content is a picture, the determining a first display content corresponding to a sub-display area of the display screen and correspondingly controlling the first display content when the motion sensor senses a first motion of the electronic device, comprises:
determining the corresponding first display content is the picture in the sub-display area, or the entire picture to which the picture in the sub-display area belongs; and
performing a copy operation, a marking operation, or a storing operation on the corresponding first display content.

19. The method according to claim 13, further comprising:
changing the color of a link when the link moves to the sub-display area in controlling the content to scroll up or down in response to the forward tilting motion or the backward tilting motion of the electronic device, and
opening the link and displaying an opening progress bar of the link when the motion sensor senses that the electronic device returns to a preset position, and
controlling the second display content to jump to a link interface when the opening progress bar is completed.

20. The electronic device according to claim 1, wherein the sub-display area is a part of an entire display area, and the first display content is a part of a second display content displayed on the entire display area.
